(19) United States
(12) Patent Application Publication
(10) Pub. No.: US 2023/0012078 A1
(43) Pub. Date: Jan. 12, 2023

(54) ILLUMINATION SYSTEM FOR OUTDOOR REGIONS

(71) Applicant: Harald PIER, Cressier (CH)

(72) Inventor: Harald Pier, Cressier (CH)

(21) Appl. No.: 17/785,557

(22) PCT Filed: Dec. 16, 2020
(86) PCT No.: PCT/EP2020/086565

§ 371 Date: Jun. 15, 2022

(30) Foreign Application Priority Data
Dec. 16, 2019 (CH) 01629/19
Mar. 16, 2020 (GB) 2003801.4

(51) Int. Cl. F21S 8/08; F21V 5/04; F21V 29/67

(52) U.S. Cl. CPC F21S 8/085; F21V 5/04; F21V 29/67; F21W 2131/103

(57) ABSTRACT

The invention relates to an illumination system (10) for illuminating outdoor regions (5), such as a sports ground, for example. The illumination system (10) comprises a plurality of lamps (10) comprising a plurality of illumination elements (20), arranged in a non-co-planar manner on a frame (50) or in at least one housing (11), for generating a plurality of light beams (25) having an optical axis (23) substantially in the direction of the outdoor regions (5) and at least one shielding element (21) arranged in an upper region (22) of the plurality of illumination elements (20), arranged so as to shield at least one part of the plurality of light beams (25) in the direction of the horizon (8) and thereabove away from the ground.

### CROSS-REFERENCE TO RELATED APPLICATIONS

None

### FIELD OF THE INVENTION

The invention relates to a lighting system for illuminating outdoor areas, such as roads, paths, sports facilities and other outdoor areas, with one or more lighting elements or light sources.

### BACKGROUND TO THE INVENTION

The present document relates to a lighting system with one or more floodlights for the illumination of outdoor areas, such as those used for the illumination of paths, roads, outdoor areas, sports fields, ski slopes, halls, etc. Such lighting systems are usually installed at a certain height above the surface of the outdoor area to be illuminated. The lighting system is usually installed on one or more poles, on a wall or a cable, on a ceiling, a roof or another component, or even on a natural body such as a rock.

### State of the Art

The luminaires used in the lighting systems, such as floodlights or streetlamps, must have sufficiently powerful lighting elements to adequately illuminate the outdoor area. The light from the luminaire is emitted by one or more lighting elements located in the luminaire and mounted on a lighting surface. The light produced by the lighting system is distributed by these lighting elements in such a way that the lighting task, i.e., the distribution of light on the surface of the outdoor space, is sufficiently achieved.

One of the problems associated with outdoor luminaires is the generation of stray light, i.e., that light which is emitted by the luminaire but not directed to illuminate the outdoor area. There are various effects in the lighting system and in the luminaires themselves that can generate an unavoidable amount of stray light. In prior art lighting systems, the direction of illumination of the stray light is generally not controlled by optical elements, so that the stray light leaves the lighting system in an essentially uncontrollable manner. These various effects include imperfections in the optical elements of the luminaires, tolerances in the assembly of the lighting system, the lighting elements themselves not being true point light sources, contamination, or even due to differential thermal expansion. Finally, other surfaces inside and outside the luminaires are irradiated by the light and reflect or scatter the light in random directions.

The effect of this reflected and scattered stray light means that the light from the lighting system is often emitted in directions that cannot be controlled and used to fulfil the lighting task. Even in these scattered light directions, the lighting system is perceived as a bright point of light because the relatively small light emission surface of the luminaire at this point leads to a very high luminance compared to the dark surroundings and also compared to the illuminated surface of the outdoor area.

Currently, light-emitting diodes (LEDs) are the preferred lighting elements in luminaires.

The lighting systems designed according to the state of the art have one or more light emission surfaces that are essentially planar or flat in nature. These light emission surfaces usually occupy almost the entire surface of the luminaire, especially in the case of high-power lighting systems that are used to illuminate large areas. The minimum area of a prior art luminaire is determined by the number of individual LEDs required to provide sufficient total luminous flux and the size of the optics associated with the LEDs. The size of these optics depends on the required concentration of the light beams emerging from the LEDs and the size of the light emission surfaces of the LEDs.

An example of a lighting system using LEDs is known from US Pat. Publication No. US 9,581,303 B2 (Gordin et al.), which discloses a lighting system using a plurality of LED lighting elements and in which a long operating life can be reasonably assured by teaching the requirements of the application, the characteristics of the LEDs, the characteristics of the luminaire comprising those LEDs, the desired number of hours of operation, and an iterative approach to powering the LEDs. LED lighting elements are individually provided with a shape, designed to block a portion of the light from the light emitting surface of a lens at preferred angles. The LED lighting elements are provided with black light-absorbing viewing screens designed to illuminate a target area but absorb light that could cause glare.

Planar surfaces of the luminaires are aligned in a mounting position, e.g., on a support element such as a pole, frame or post, in such a way that in combination with the other lighting elements of the lighting system surrounding the outdoor area to be illuminated, an acceptable, i.e., standards-compliant, light distribution is achieved on the surface of the outdoor area. This orientation of the light emitting surfaces means that such lighting systems are often visible from a very long distance, as the lighting systems are arranged on the support element at a distance above the surface of the illuminated outdoor area. The stray light is distributed in many directions and does not contribute to the lighting task. Even if the lighting system could in principle be arranged in such a way that no stray light is seen from a distance, an angular portion of the light rays of the lighting system remains below the horizon within which the emitted light does not contribute to the lighting task of the outdoor area.

Another example of a lighting system with LEDs and shielding elements to prevent stray light is the ALO lighting system from AEC. Details of this lighting system can be found on the website http://alo.aecilluminazione.com (downloaded on 16 Mar. 2020). It shows the LED lighting elements mounted on a flat, level surface with a large light-emitting area. The optical axes of these LED lighting elements are perpendicular to the flat, plane surface.

As already mentioned, the state of the art lighting systems are visible from a great distance as bright points of light. These points of light are undesirable for several reasons. Sports facilities are often located in or near residential areas, and there have been an increasing number of cases where residents have complained about light nuisance caused by lighting systems placed near residents’ windows. The lighting systems are said to cause unpleasant effects and glare through the windows due to the cool white light of the LEDs in the luminaires combined with the very bright light emitting surfaces of the lighting system.

A vehicle driver on a traffic route will observe these light points, which appear much brighter than the roadway itself and may be distracted by them. Light pollution, itself caused by the almost horizontally emitted light, is an unpleasant side effect of lighting squares and roads.

The lighting systems are also attractive to nocturnal animals and insects, which then move towards the lighting systems. The insects may eventually die exhausted because they are in an “orbit” around the light points due to the distance to the lighting system and staying there.

Typical luminaires in state-of-the-art lighting systems for sports facilities, for example, weigh 20-30 kilograms and emit between 120000-200000 lumens. The beam angle required for this is about 20 degrees or less. A clear demarcation in illumination between the illuminated and non-illuminated area is also a challenge with the known state of the art and is usually due to the fact that parts of the light emitting surface still remain visible, and these always emit light into the entire half-space even under optimal conditions.

In addition, the high luminous flux requires a large number of lighting elements with associated optics. In order to generate the required radiation characteristics, these optics must have a size of approx. 8-10 times the edge length of the radiating LED chip surface. A maximum of 300-400 lumens can thus be generated per square centimetre. However, this value is dramatically reduced if asymmetrical distribution is required, as is the case with the luminaires used today. Alternatively, the luminaires could be erected, but this would inevitably lead to radiation towards the horizon and beyond.

Another challenge with asymmetrical radiation is that the required optics need a much larger surface area, as the light from an LED should be deflected as well as possible to only one side. Too close an arrangement of LEDs or optics leads to mutual shadowing and thus to loss of efficiency and more scattering. Due to this fact, known luminaires typically have dimensions of at least 60 cm by 60 cm, which also results in the previously mentioned weight. Significantly larger versions can also be found.

It is the task of the present disclosure to provide a lighting system with low weight and a high luminous flux with little scattered radiation.

### SUMMARY OF THE INVENTION

The lighting system of the present document is adapted for illuminating outdoor areas such as sports fields and comprises a plurality of luminaires having a plurality of lighting elements or light sources arranged on a frame in a non-coplanar arrangement for producing a plurality of light beams having an optical axis substantially in the direction of the outdoor areas. At least one shielding element is disposed in an upper portion of the plurality of lighting elements to shield at least most of the plurality of light rays towards the horizon and above (away from the earth).

The non-coplanar arrangement of the lighting elements on the frame means that the optical axes of the lighting elements are not parallel to each other and the optical axes of the lighting elements will cross at some point in space.

In one aspect, the lighting elements are light emitting diodes.

In a further aspect, the illumination system further comprises focusing optic(s) for focusing light beams in a targeted direction.

In a further aspect, the lighting elements comprise a plurality of light emitting diodes arranged in at least one of an offset pattern or a hexagonal pattern. In this way, a uniform light distribution can be produced.

In another aspect, the light rays exit the focusing optic(s) at an angle of less than 25°. As a result, most of the light from the illumination elements is directed along the optical axis.

In another aspect, several of the plurality of lighting elements are arranged in a convex manner. This allows for better shielding of stray light.

In another aspect, optical axes of the plurality of lighting elements cross in a geometric spatial region in front of the lighting elements.

In another aspect, a plurality of the plurality of illumination elements are arranged in a frame or in the housing. The arrangement in a frame or housing can influence the orientation of the optical axis.

In a further aspect, the frame and/or the housing is attached to at least one pole.

In a further aspect, the at least one shielding element is arranged in a lateral region. The light rays from the illumination element(s) can thereby be shielded on either side of a light emitting surface.

In a further aspect, a length of the plurality of shielding elements is less than 40 cm, preferably less than 20 cm. This can further reduce the size or dimension of the luminaire.

In a further aspect, the plurality of lighting elements has a light emission width of less than 10 cm, preferably less than 5 cm. This can further reduce the size or dimension of the luminaire.

In a further aspect, each of the plurality of lighting elements can be rotated through an angle ß and tilted through an angle n. This allows each of the individual lighting elements to be rotated and tilted by adjusting the angles Ω and β to provide uniform illumination of the outdoor area.

### Description of the Figures

FIG. 1 shows a lighting system that illuminates an outdoor sports field

FIG. 2 shows the distribution of light from luminaires.

FIG. 3 shows a luminaire with a multitude of lighting elements.

FIG. 4 shows a lighting element with a plurality of light-emitting diodes.

FIG. 5 illustrates the shielding of light from luminaires.

FIG. 6 shows the principle of a shielding element.

FIG. 7 shows the screening elements on a sports field.

FIG. 8 shows another schematic construction example of the luminaire.

FIG. 9 is a perspective view of the lamp from FIG. 8.

### DESCRIPTION OF THE INVENTION

On the basis of the drawings, the invention is now described. It is understood that the embodiments and aspects of the invention described herein are examples only and do not limit the scope of protection of the claims in any way. The invention is defined by the claims and their equivalents. It is understood that features of one aspect or embodiment of the invention may be combined with a feature of another aspect or other aspects and/or embodiments of the invention.

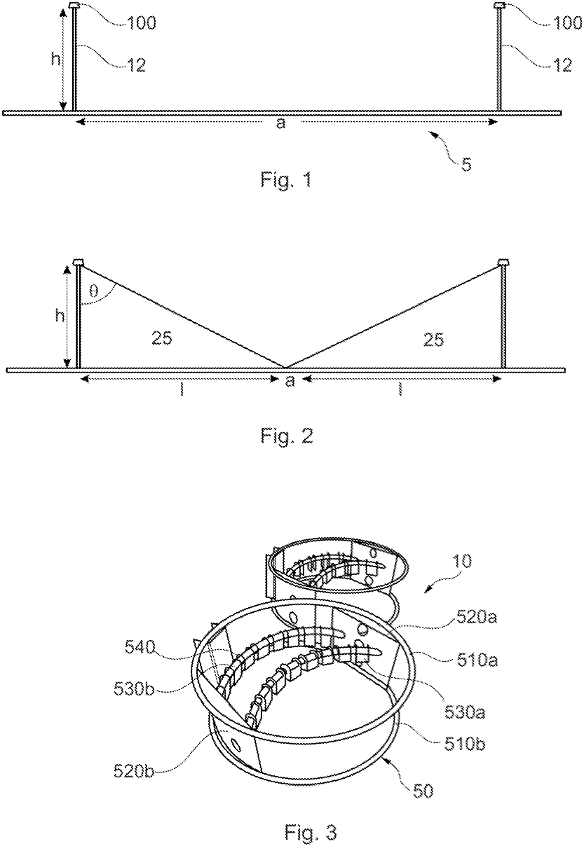

For a better understanding of the invention, it is helpful to take a closer look at the arrangement of lighting systems 100 for illuminating an outdoor area 5. Such an exemplary arrangement is shown in FIG. 1 for lighting a sports field. The lighting system 100 comprises a plurality of luminaires 10 (also referred to as floodlight luminaires in the context of a sports field or an airport apron) arranged on support elements, such as poles 12, at a height h of between 12 m (metres) and 20 m above the surface of the outdoor area 5. It should be noted that these dimensions are not a limitation of the invention. The lights 10 comprise a plurality of lighting elements 20 or light sources 20 comprising a plurality of light emitting diodes (LEDs), as shown in FIG. 3. The height h of the poles 12 used in other applications, such as airports or stadiums, is also significantly higher, for example up to about 40 m. The minimum area to be illuminated in a direction perpendicular to the mast 12 typically has a beam distance 1, as shown in FIGS. 2 and 7, between 4-7 times the height h of the mast 12. For example, this results in a beam distance 1 of about 60-70 m for sports fields, such as a football field. At airports or stadiums with the higher masts 12, the radiation distance 1 is correspondingly greater. It is estimated that in practice the area of outdoor area 5 illuminated by different of the luminaires 10 will overlap. FIG. 7 shows another arrangement in which the luminaire 10 is mounted on a mast 12 and illuminates the entire sports field.

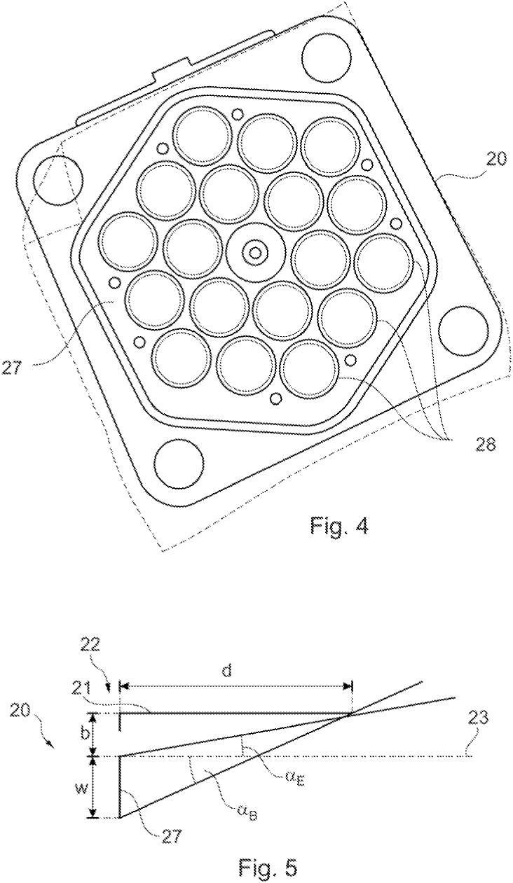

The distances between the luminaires 10 mounted at the top of the mast 12 and a maximum beam distance lₘₐₓ (see FIG. 7) of the illuminated area of the outdoor area 5 can be large, e.g., over 50 m. The luminaires 10 are therefore provided with bundling optic(s) 28 (see FIG. 4) in the plurality of lighting elements 20 in order to bundle light beams 25 (see FIG. 2) of the plurality of lighting elements 20 in a targeted direction and to achieve a sufficient illuminance of the surface of the outdoor area 5. It is known that the degree of illuminance of the lighting elements 20 decreases with the square of the distance between the lighting elements 20 in the luminaire 10, due to the inverse square law. Therefore, the shaping or concentration of the light beams 25 of the lighting elements 20 must be mainly in the direction of the maximum radiation distance lₘₐₓ on the surface of the outdoor area 5. This direction is only a few degrees wide, as can be understood from simple geometric considerations and will be explained in more detail later.

The relationship between the size of the light emitting surface of the luminaire 10 and the size of the focusing optic(s) 28 used to shape and concentrate the direction of light determines the degree of concentration of the light rays 25 from the illumination elements 20 that can be achieved. The laws of optics state that the narrower the degree of concentration of the light rays 25 required by the focusing optic(s) 28, the larger the size of the focusing optic(s) 28.

On the other hand, due to static considerations of the poles 12, the luminaires 10 may not become very large or heavy as the poles 12 may not be able to support the additional weight or wind load. The size of the focusing optic(s) 28 in the luminaire 10 required to sufficiently shape the light therefore limits the number of lighting elements 20, which in turn limits the achievable luminous flux of the light from the luminaires 10. On the other hand, due to the same considerations, it is not possible to attach any number of luminaires to a pole 12, so that the luminous flux achievable on a pole with a given load is in practice strictly limited by the prior art.

A non-limiting first example of the construction of the luminaires 10 is now described with reference to FIG. 3, which shows a luminaire 10 as would be used, for example, for floodlighting a sports field. It can be seen that the luminaire 10 in FIG. 3 comprises a frame 50, consisting of two annular elements 510a and 510b arranged in parallel. The two annular elements 510a and 510b are connected to each other by spacer plates 520a and 520b. Two curved beams 530a and 530b are arranged between the two spacer plates 520a and 520b. The curved beams 530a and 530b have a plurality of holders 540 into which a plurality of the lighting elements 20 are/will be convexly mounted. The convex mounting method assists in shielding stray light. It will be appreciated that other non-planar surface structures may be used as long as they direct light from the plurality of illumination elements 20 into the exterior area 5. This results in optical axes 23 of the illumination elements 20 crossing in a geometric region of space in front of the illumination elements. For clarity, it should be noted that this spatial region of intersection of at least two optical axes 23 is not necessarily on the surface of the outdoor area 5 but could be in a space “below ground” or in the air above the surface of the outdoor area 5. The holders 540 may be rotated about the curved supports 530a and 530b to allow the illumination elements 20, arranged in one of the plurality of holders 540, to direct light in different directions.

As mentioned above, the construction of the lights 10 shown in FIG. 3 is only exemplary. The frame comprising the annular elements 510a and 510b and the spacer plates 520a and 520b is not a limitation of the invention and could take different shapes, such as an oval shape or a rectangular shape. The number of supports 530a and 530b in the light fixture 10 can also be changed if necessary, and the number of holders 540 is also not a limitation of the invention.

It would also be appreciated that two or more of the frames 50 could be mounted together on one of the poles 12 and this would be suitable for luminaires 10 placed in floodlights to illuminate a larger area than a sports field. It would also be appreciated that much smaller luminaires 10 could be used for street lighting. For example, these small luminaires 10 could comprise only one or two of the lighting elements 20.

FIG. 4 shows an example of one of the illumination elements 20. It can be seen that the illumination elements 20 comprise a plurality of light emitting diodes arranged in a staggered manner to form a hexagonal or hexagonal arrangement in a light emitting surface 27, but this arrangement is not a limitation of the invention and shapes other than a circular shape or a rectangular shape could be chosen for the plurality of illumination elements 20. The hexagonal arrangement was chosen because this arrangement produces a substantially uniform beam of light from the light emitting surface 27 of the lighting element 20, as well as the highest density of light emitting diodes, thereby reducing the overall size of the light emitting surface 27. The colour characteristics of the illumination elements 20 may be identical or different from each other. In one non-limiting aspect, the illumination elements 20 have a maximum light emitting area 27 in a direction approximately perpendicular to an emitting direction of 50 mm (millimetres). In other aspects, the illumination elements have a smaller maximum light emitting surface 27 in the sense mentioned, for example of at most 36 mm or even at most 25 mm. The illumination elements 20 are covered by the focusing optic(s) 28 and emit light in light beams 25 in the direction of an optical axis substantially perpendicular to the plane of the light emitting surface 27. This optical axis 23 generally corresponds to the direction in which the light from the illumination elements 20 must be focused and shaped to produce an illumination characteristic required for the desired outdoor area 5. The light rays 25 from the illumination elements 20 shown in FIG. 4 exit the focusing optic(s) 28 at an angle of less than 25° (degrees) in one aspect and exit the focusing optic(s) 28 at an angle of less than 10° in another aspect.

This reduction in size of the lighting elements 20 initially seems to contradict the intuition of the person skilled in the art. The light of the illumination elements 20 should be concentrated in a beam shape exactly in the direction perpendicular to the light emission surface 27. At the same time, the bundling optic(s) 28 must not be particularly large in this direction, which actually prevents the concentration. However, as will be shown further below, this is a prerequisite for making it possible to shield the light and thus reduce the stray light and the visibility of the light-emitting surfaces 27 from outside the area of the outdoor area 5 to be illuminated.

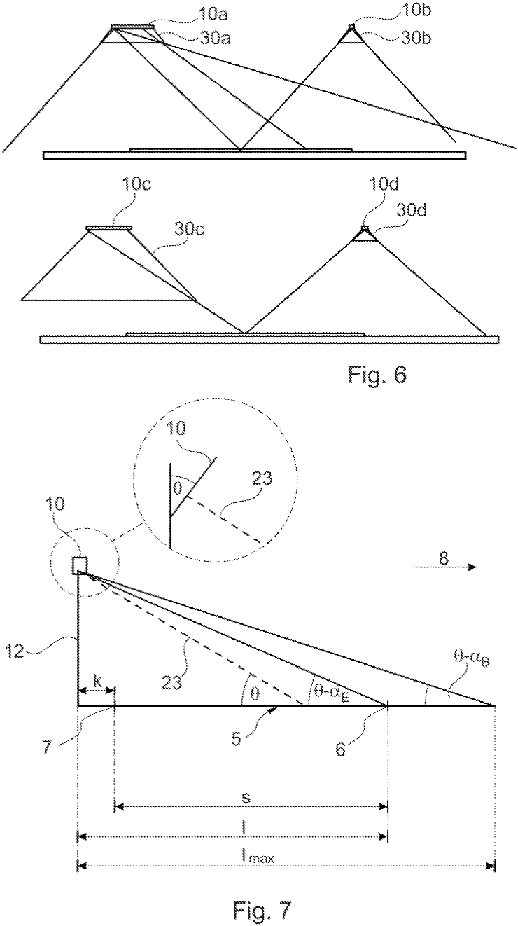

FIG. 6 illustrates this dilemma with luminaires 10 known in the prior art by means of two representations (top and bottom). In the upper FIG. 6, two luminaires 10a and 10b are shown which are equipped with shielding elements 30a and 30b. In this example, the light-emitting surfaces of both luminaires are arranged horizontally, as is typical for street lighting. The luminaire 10a on the left has a larger light-emitting surface than the luminaire 10b on the right. The shielding elements 30a and 30b in the upper FIG. 6 are the same size, but it can be seen that the effective beam angle of the light from the left-hand luminaire 10a is greater than the effective beam angle of the light from the right-hand luminaire 10b. As a result, a larger area is illuminated, or more stray light is produced in undesirable directions. The very bright light-emitting surface of the lamp 10a is therefore visible from more directions and from a greater distance than the light-emitting surface of the lamp 10b.

This can be compared with the lower FIG. 6, in which the illumination area of the left lamp 10c and the right lamp 10d are the same size. However, the size of the shielding element 30c of the left lamp 10c is substantially larger than the size of the shielding element 30d of the right lamp 10d. As mentioned above, the increase in size of the shielding elements 30c (compared to 30a) means an increase in weight and wind resistance that may not be borne by the poles 12.

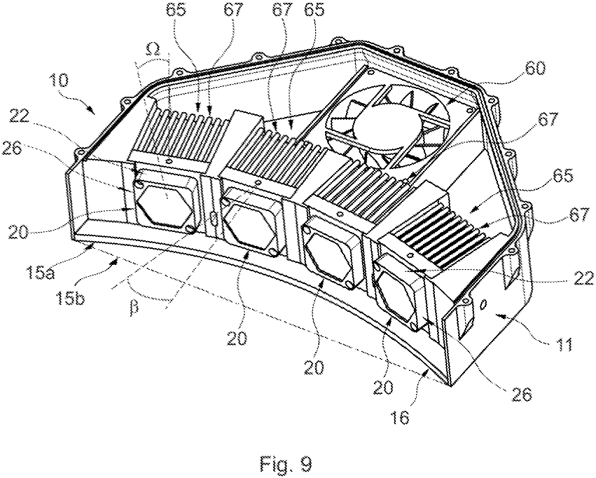

In the lighting system 100 of this document, the lighting elements 20 of the luminaire are provided with an individual shielding element 21, as shown with reference to FIG. 5. For the illumination of sports facilities, the lighting elements are expediently installed in such a way that the maximum of their radiation is directed substantially towards the most distant area to be illuminated, as described below by way of example. The lighting elements 20 comprise the light emitting surface 27 having a vertical dimension or light emitting width w (i.e., dimension substantially perpendicular to the plane of the surface of the outdoor area 5) and the optical axis 23, extending perpendicular to the plane of the light emitting surface 27. The shielding element 21 has a length d and is mounted at a distance b from the edge of the light emitting surface 27 and is arranged in the upper region 22 of the lighting element 20. In a further aspect, further shielding elements 21 may also be arranged in a region other than the upper region 22, for example laterally on the lighting element(s) 20. Accordingly, the lighting element(s) 20 comprise the upper region 22 and one or more lateral region(s) 26 as shown in FIG. 9. It is understood that the shielding element 21 shields the light between the angles α_{ε} and α_{B}, the angles between the end of the shielding element 21 and the optical axis 23, as shown in FIG. 6. In a non-limiting example, the at least one shielding element 21 could be configured as a curved or straight element, with or without reflective members, which completely or at least substantially covers the light source(s). This means that the light emission surface 27 of the illumination element is shielded from a viewing angle of α_{ε} angle of view and this shielding is completed from the angle α_{B} i.e., the light-emitting surface is no longer visible at angles >_{α} is no longer visible and thus the lighting element 20 appears dark. This angle thus corresponds to an imaginary viewing direction of an observer with respect to the optical axis 23.

It is known from mathematics that tan α_{ε} = b/d . Similarly, tan α_{B} = (b + w)/d . The light from the lighting element 20 will therefore not begin to scatter until the value of the angle α_{B} is selected to shield areas outside the surface of the outdoor area 5 to be illuminated. The angle α_{B} has the greater value and is the angle which, if not set correctly, will cause the greatest amount of scattered light.

How this works on a sports field as an outdoor area 5 is shown in FIG. 7, which shows the luminaire 10 mounted on the pole 12. In the detail of FIG. 7, it can be seen that the optical axis 23 of the luminaire 10 is tilted obliquely downwards by the tilt angle Θ to direct the light onto the outdoor area 5 to be illuminated. The optical axis 23 of the light-emitting surface 27 of a lighting element 20 within a luminaire 10 is therefore arranged so that it points at most towards or just beside the sports field. The pole 12 is mounted on one side of the sports field and the luminaires 10 are intended to illuminate transversely or diagonally to the other side of the sports field, i.e., at most slightly beyond the end of the sports field. This can be achieved as shown in FIG. 7. However, the length d of the shielding element 21 (see FIG. 5) should be chosen so that the outermost illumination angle Θ-α_{B} illuminates only a small area outside the sports field, in a direction parallel to the earth’s surface towards horizon 8, as indicated by the directional arrow. To ensure full illumination of the sports field by the luminaire 10, the angle of illumination must be Θ-α_{ε}must substantially coincide with a first edge 6 of the sports field. In combination with a mirrored shielding element and the suitably narrowly selected beam angle of the lighting element 20, it is thus ensured that almost all of the radiated light impinges on the playing field, which essentially represents the outdoor area 5 to be illuminated.

In practice, the luminaire 10 has a plurality of lighting elements 20 mounted at different tilt angles Θ to provide largely uniform illumination of the sports field.

The shielding elements 21 can be provided with a light-absorbing layer consisting of, for example, a matt black lacquer layer or anodising on the shielding element. More commonly, the shielding elements 21 will be mirrors that reflect light onto the sports court. In one aspect, the shielding element 21 may shield at least one of the plurality of lighting elements 20. In another aspect, the shielding element 21 may shield a plurality of lighting elements 20.

An example of the dimensions is now given. Assume that the distance of the mast 12 to a second edge 7 of the sports field is k and the width of the sports field is s (see FIG. 7). The height of the mast is h (as above). Let the greatest possible value of α_{B} is given if it is equal to the value of the tilt angle Θ at which the light begins to shine parallel to the earth’s surface in the direction of the horizon 8. It is known that and

$$tan {α}_{B} = {}^{( b + w )} / {}_{d}$$

$$tan Θ = \frac{( h )}{( k + s )}$$

This means that

$${}^{( b + w )} / {}_{d} = \frac{( h )}{( k + s )}$$

or

$$w = \left(\frac{( h ) . d}{( \text{} k + \left.s\right)}\right) - b$$

Let us assume that the light emission width w of the light emission surface 27 is about 10 cm, the length d of the shielding element 21 is 40 cm (centimetres) (0.4 m) and the height h of the mast 12 is 18 m. If the width s of a football sports field is equal to 64 m and the distance k of the mast 12 to the second edge 7 of the sports field is equal to 3.5 m, then (k+s) is equal to 67.5 m. If the distance b is furthermore zero, then this means that the associated tilt angle Θ would have to be a limit value of at least about 15° for this case. It should be noted that this is a minimum requirement, namely that the light emission surfaces must not be visible from positions above their mounting plane. Even this minimum requirement is not currently achieved by most state-of-the-art lighting systems for sports facilities. In addition, shielding elements of a size of 40 cm are not feasible in practice, as they represent a considerable additional wind load due to their planar structure, and a large number of such shielding elements may be required per luminaire 10.

In practice, an even smaller light emission width w of around 5 cm (0.05 m) is desired. This is because this basic calculation would only limit the emission of stray light and thus the visibility of the high luminance lighting elements up to horizon 8. In practice, however, it is also to be avoided that the light hits close to building facades, trees or simply does not hit the outdoor area 5 to be illuminated outside the target outdoor area. Therefore, the value of the angle α_{B} should be less than and not equal to the value of the tilt angle Θ as shown in the example above.

It is possible to assume the maximum value of the angle α_{B} assuming that at a distance of 80 m from mast 12 it is undesirable to have an emission of light of more than 2 m in a direction perpendicular to the earth’s surface. This would roughly correspond to a typical residential situation with buildings not too far from the sports field. In this case, the equation would be:

$$\text{(18m-2m)/80m} \text{=} \text{0} \text{.2} \text{tan} \text{(} Θ \text{-} {α}_{\text{B}} \text{)}$$

The value of the tilt angle O cannot be chosen arbitrarily. It corresponds to the angle of the vertex of the light emission of a lighting element of a luminaire 10. As already mentioned, most of the light is needed at least in the centre of the sports field, where the value of the angle is Θ is calculated from tan Θ = 18 m/(64 m/2+3.5 m) = 0.5 in the best case. It should be noted that masts 12 are often only 16 m or 14 m high, and some overlap of light distributions in the centre is highly desirable. With these more practical figures, the following equations are obtained:

$$0.2 = tan \left(Θ - {α}_{\text{B}}\right) ; Θ - {α}_{\text{B}} = 11 , 3 {}^{∘} ;$$

$${α}_{\text{B}} = Θ - 11 , {3}^{∘} = 26 , {6}^{∘} - 11 , {3}^{∘} = 15 , {3}^{∘} ,$$

Therefore, since

$$\text{tan} {α}_{\text{B}} \text{=} \frac{\text{(b+w)}}{\text{d}}$$

$$\text{b} \text{} \text{} \text{+} \text{w} \text{=} \text{d} ∗ \text{tan} {α}_{\text{B}} \text{=} \text{d} ∗ \text{0} \text{.27}$$

This is indeed, in the best case, the practical limit for the complete limitation of lighting elements for the illumination of a football pitch, but also applies with adjusted values for mast height and surface orientation and size for other outdoor lighting applications. With a length of the shielding element d = 20 cm, there is a smaller light emission width w of around 5 cm (0.05 m) compared to the case described above, which limits the radiation of the light coming from the light emission surface w only to horizon 8. The shallow angle of incidence of the light on the horizontal surface creates an area over which the light is dimmed from full intensity to zero. In FIG. 7, this area corresponds to the distance between the intersection points of the tilt angles Θ — α_{B} and Θ — α_{E} with the plane of the sports field. This distance is used for smaller tilt angles Θ corresponding to lower mast heights h and shorter apertures. To achieve the same shielding effect, the ratio of the length of the shielding element d and the light emission width w plus the distance b to the shielding element must always be the same. This means that the value b should be as small as possible, ideally even 0, and the light emission width w should also be as small as possible, which in turn conflicts with the requirement of tight bundling. This dilemma can be solved by using appropriately high-powered light sources as shown in FIG. 4.

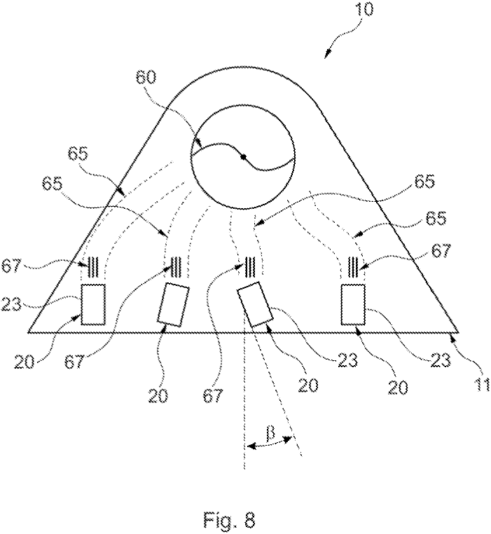

A further construction example of the luminaire 10 is shown in FIG. 8 and FIG. 9 without shielding element(s) 21. In this case, the luminaire 10 comprises one or more housings 11, each of which comprises a plurality of lighting elements 20 and optionally one or more optional fans 60. A housing 11 may be made, for example, from a sheet metal structure, by casting, or also by additive manufacturing. Such an enclosure 11 includes cooling channels 65 between a lid 18 and base 16 of the enclosure 11, and cooling elements 67. The cooling elements 67 are attached to the rear of the illumination means 20 and are in the form of, for example, fins, fins, honeycombs, and other shapes, and serve to provide a greater surface area to dissipate heat generated by the illumination means 20 to the environment. To further increase the dissipation of heat, ambient air is directed through the cooling channels 65 to the cooling elements 67 and/or the lighting means 20. The optional fan(s) 60 may be an axial fan or radial fan. In one aspect, the one or more fans 60 is a radial fan. The fan 60 may be driven by a known method, such as by an electric motor (not shown).

The cooling channels 65 and cooling elements 67 can be manufactured together with the housing or separately from the housing 11 by additive manufacturing. This means that the construction of the housing 11, the cooling channels 65 and cooling elements 67 can be individually adapted. In particular, the shape and number of cooling channels 65 can be customised. If desired, the shape of the housing 11 can also include other elements serving to dissipate the heat.

The lighting elements 20 are placed and mounted in the housing 11. In one aspect, each of the lighting elements 20 can be oriented at a different angle n tv the housing 11. The angle Ω may be set in a range between -50° and 0° relative to an initial position. The optical axis 23 of each of the illumination elements 20 may further be individually adjusted in such a manner by rotating the illumination elements 20 through an angle β prior to fixing. The angle β can be adjusted in a range between -40° and 40°. The angle β depends on the position of the respective lighting element 20 in the respective housing 11 and the respective application. Additive manufacturing enables adjustment of the beam direction of the lighting elements 20 by integrated construction of the angle Ω and angle β in the housing 11. Rotatability and tilting of the individual lighting elements 20 by adjusting the angles Ω and angle β enables uniform illumination of the outdoor area 5 to be achieved. As shown in FIG. 9, such a housing 11 may comprise a non-straight (curved) front 15a. However, the enclosure 11 may also comprise a straight front 15b as indicated by the dashed line. In one aspect, further openings or constructions may be provided, for example without intending to limit the invention, for conduit routing and seals.

The above geometric calculations also apply to differently oriented light-emitting surfaces and asymmetrical beam patterns. The projection of the light emitting surface onto a plane perpendicular to the optical axis 23 must be taken into account, as well as the vertical extension of the shielding element in relation to this light emitting surface w of the illumination elements 20. Therefore, the above calculations are universal and do not limit the invention to the use of symmetrical focusing optics/s in the illumination elements 20, the use of planar shielding elements (since only the vertical displacement of the outer edge of the shielding elements with respect to the position of the illumination element is taken into account) or other features mentioned by way of example in this description.

With the lighting system 100 disclosed here, a luminous flux of around 30,000 lumens per housing 11 can be achieved at a weight of less than 2 kilograms. With, for example, five housings 11 per luminaire 10, a luminous flux of around 150,000 lumens can thus be generated at a net weight of 10 kilograms. Added to this is the weight of a holding device, such as a frame 50 from FIG. 3. Compared to the luminaires known from the state of the art, this corresponds to a weight reduction of up to 50% with the same luminous flux, but much better directed radiation. With ten luminaires 10, a luminous flux of about 1,500,000 lumens can be generated at a weight of about 20 kilograms per luminaire. Compared to the known luminaires from the state of the art, this corresponds to a significantly lower weight per pole, as the more precise illumination achieved also requires less light than the state of the art. This saves resources and also simplifies the installation of a lighting system 100 according to the invention.

For example, a luminous flux of just under one million lumens would be required to illuminate a category 4 (elite) football stadium, with a required illuminance of approximately 140 lux and a playing surface of 7,140 m² (square metres). With the lighting system 100 taught here, it would be possible to provide eight poles 12, with the centre poles each comprising two luminaires 10 each with five housings 11 and four corner poles each comprising one luminaire 10 each with five housings 11.

### REFERENCE SIGN

5 Outdoor area/s
6 First edge of the sports field
7 second edge of the sports field.
8 Horizon
10 Luminaire
11 Housing
12 Mast
16 Floor
15a a non-straight front
15b straight front
18 Lid
20 Lighting element/s
21 Shielding element(s)
22 Upper range
23 Optical axis
24 LEDs
25 Light rays
26 Side area
27 Light-emitting surface
50 Frame
510a,b Ring-shaped elements
520a,b Spacer plates
530a,b Curved beams
540 Holder
60 Fan
65 Cooling channels
67 Cooling elements

1. A lighting system comprising a plurality of lights for illuminating outdoor areas, the lights comprising:
a plurality of lighting elements arranged in a non-coplanar manner on a frame or in at least one housing to produce a plurality of light beams with an optical axis substantially in the direction of the outer regions;
at least one shielding element arranged in an upper region of the plurality of lighting elements, arranged to shield at least part of the plurality of light rays towards the horizon and away from the earth there above.

2. The lighting system according to claim 1, wherein the lighting elements (20) are light emitting diodes.

3. The lighting system according to claim 2, further comprising focusing optics(s) for focusing light beams in a targeted direction.

4. The lighting system according to claim 1, wherein the lighting elements comprise a plurality of light emitting diodes arranged in at least one of an offset pattern or a hexagonal pattern.

5. The lighting system according to claim 3 , wherein the light beams emerge from the focusing optic(s) at an angle of less than 25°.

6. The lighting system according to claim 1, wherein a plurality of said plurality of lighting elements (20) are arranged in a convex manner.

7. The lighting system according to claim 1, wherein optical axes of the plurality of illumination elements intersect in a geometric spatial region in front of the illumination elements.

8. The lighting system according to claim 1, wherein a plurality of said plurality of lighting elements (20) are arranged in a frame or in said housing.

9. The lighting system according to claim 8, wherein the frame and/or the housing is attached to at least one pole.

10. The lighting system according to claim 1, wherein the at least one shielding element is arranged at a lateral region .

11. The lighting system according to claim 1, wherein a length (d) of the plurality of shielding elements is less than 40 cm, preferably less than 20 cm.

12. The lighting system according to claim 1, wherein the plurality of lighting elements has a light emission width (w) of less than 10 cm, preferably less than 5 cm.

13. The lighting system according to claim 1, wherein each one of the plurality of lighting elements can be rotated through an angle β and tilted through an angle Ω.
